(19) United States
(12) Patent Application Publication
(10) Pub. No.: US 2009/0053998 A1
(43) Pub. Date: Feb. 26, 2009

(54) APPARATUS AND METHOD FOR REDUCING POWER CONSUMPTION BY MOBILE ELECTRONIC DEVICES DURING RADIO COMMUNICATION

(76) Inventor: Thomas Nikita Krupenkin, Middleton, WI (US)

Correspondence Address: Thomas Krupenkin;Univ of Wisconsin Madison, Dept. of Mechanical Engineering, 1513 University Ave., Madison, WI, 53706, US

(21) Appl. No.: 12/196,279

(22) Filed: Aug. 21, 2008

Related U.S. Application Data
(60) Provisional application No. 60/957,190, filed on Aug. 22, 2007.

(51) Int. Cl. H04B 7/00

(52) U.S. Cl. 455/41.2

(57) ABSTRACT

An apparatus comprising an energy-harvesting means and a radio frequency (RF) communication means. Said energy-harvesting means is configured to capture mechanical energy from the human motion and convert it to useful electrical energy. Said RF communication means is configured to establish RF communication with the mobile electronic devices in its vicinity using low-power, short-range RF communication signals. Said RF communication means is further configured to retransmit the information received through said short range RF communication signals using high-power long-range communication signals, thereby allowing said mobile electronic devices to establish a long-range RF communication with the remote recipient substantially utilizing the energy derived from the energy-harvesting means rather than the energy predominantly derived from said mobile electronic devices themselves

### CROSS REFERENCE TO RELATED APPLICATIONS

This application is derived from and claims the benefit of the filing date of U.S. Provisional Patent Application No. 60957190 entitled “FOOTWEAR WITH ENERGY HARVESTER POWERED WIRELESS TRANSCEIVER”, inventor: Thomas Nikita Krupenkin, filed on Aug. 22, 2007, which is incorporated herein in its entirety by reference.

### TECHNICAL FIELD OF THE INVENTION

The present invention is directed, in general, to a device for reducing the energy consumption and improving the performance of the mobile electronic devices that use radio frequency (RF) communication, and methods for using and manufacturing such a device.

### BACKGROUND OF THE INVENTION

One of the most high power consumption activities performed by personal mobile electronic devices is long-range radio frequency (RF) communication, such as the one required to communicate with the wide area cellular telephone network. The long-range RF communication power requirements can hundreds of times exceed power requirements for the normal mobile device operation or for a short-range RF communications such as those conforming to Bluetooth or Wibree standards. The high power required for long-range RF communications leads to accelerated battery discharge in many mobile electronic devices, such as cell phones, laptops with Wide Area Network (WAN) cards, personal digital assistants (PDA), etc.

Thus substantial decrease in power consumption by these devices can be achieved if their long-range RF transmission is minimized or even completely excluded. One of the ways to achieve this is to perform RF communications through an intermediate transceiver (i.e. RF transmit-receive unit) that receives communications from the mobile devices in a low-power standard such as Bluetooth or Wibree and then retransmits them through a long-range high-power RF link, such as CDMA2000 or G3 wide area cellular telephone network link.

Since both short-range and long-range communications are performed wirelessly the transceiver location can be anywhere in the vicinity of the mobile devices. In particular, it might be advantageous to position the transceiver at the place where effective energy-harvesting device can be located.

Energy harvesting devices are designed to capture the ambient energy surrounding the electronics and convert it into usable electrical energy. The concept of energy harvesting works towards developing self-powered devices that do not require replaceable power supplies.

Many types of energy harvesters exist, each offering differing degrees of usefulness depending on the application and the harvester output power level. In cases where high mobility and relatively high power output is required, harvesters that convert mechanical energy into electrical energy are particularly promising as they can tap into high power sources such as human motion. For instance, one of the promising ways to extract energy from people's motion is by tapping their gait. Humans typically exert up to 130 percent of their weight across their shoes at heel strike and toe-off, and standard jogging sneakers cushioned soles can compress by up to a centimeter during a normal walk. For a 154-pound person, this indicates that about 7 Watt of power could be available per foot at a 1-Hertz stride from heel strike alone. This is more than sufficient to operate such load as a mobile phone, which typically consumes power on the order of 1 to 2 Watt during RF transmission.

A number of proposals exist to use energy harvested from human motion for various purposes, including powering mobile electronic devices. Some of those methods are disclosed in U.S. Pat. Nos. 5,167,082, 5,495,682, 4,660,305, 6,239,501, 6,744,145, 6,281,594, which are incorporated by reference herein in their entirety. However, non of the above mentioned references propose to use the human-motion-powered energy harvesting device coupled with the RF transceiver for the purpose of reducing the energy consumption and improving the performance of the mobile electronic devices that use long-range radio frequency (RF) communication.

Thus there clearly exists a need for an efficient, yet compact and simple device capable of harvesting useful energy from human motion and utilizing it for retransmission of RF communication signals received from the mobile electronic devices, therefore reducing their energy consumption and improving their performance.

### SUMMARY OF THE INVENTION

To address one or more of the above-discussed needs, one embodiment of the present invention is an apparatus. The apparatus comprises an energy-harvesting means and a radio frequency (RF) communication means. Said energy-harvesting means is configured to capture mechanical energy from the human motion and convert it to useful electrical energy. Said energy-harvesting means and said RF communication means are electrically coupled to allow said RF communication means utilize electrical energy generated by said energy-harvesting means. Said RF communication means is configured to establish RF communication with the mobile electronic devices in its vicinity using low-power, short-range RF communication signals. Said RF communication means is further configured to retransmit the information received through said short range RF communication signals using high-power long-range communication signals, thereby allowing said mobile electronic devices to establish a long-range RF communication with the remote recipient substantially utilizing the energy derived from the energy-harvesting means rather than the energy predominantly derived from said mobile electronic devices themselves.

Another embodiment is a method of reducing the energy consumed by mobile electronic devices during long-range radio frequency (RF) communications. Said method comprises providing RF communication means and energy-harvesting means. Said method further comprises generating electrical energy from human motion by said energy-harvesting means and utilizing this energy to power said RF communication means. Said method still further comprises receiving short-range low-power RF communication signals by said RF communication means from the mobile electronic devices and retransmitting the information received through said low-power signals through high-power long-range RF communication signals, thereby allowing said mobile electronic devices to establish a long-range RF communication with the remote recipient substantially utilizing the energy derived from the energy-harvesting means rather than the energy predominantly derived from said mobile electronic devices themselves.

Still another embodiment is a method that comprises manufacturing an apparatus for reducing the energy consumed by mobile electronic devices during long-range radio frequency (RF) communications. Said method comprises disposing RF communication means and energy-harvesting means in predetermined places as to allow said energy-harvesting means to produce useful electrical energy from human motion and as to allow said RF communication means unimpeded RF communication. Electrically coupling said RF communication means and said energy-harvesting means to allow said RF communication means utilize the electrical energy produced from human motion by said energy-harvesting means. Configuring said RF communications means to receive short-range low-power RF communication signals from mobile electronic devices and retransmitting the information received through said low-power signals through high-power long-range RF communication signals, thereby allowing said mobile electronic devices to establish a long-range RF communication with the remote recipient substantially utilizing the energy derived from the energy-harvesting means rather than the energy predominantly derived from said mobile electronic devices themselves.

### BRIEF DESCRIPTION OF THE DRAWINGS

The invention is best understood from the following detailed description, when read with the accompanying figures. Various features may not be drawn to scale and may be arbitrarily increased or reduced in size for clarity of discussion. Reference is now made to the following descriptions taken in conjunction with the accompanying drawings, in which:

FIG. 1 provides a schematic representation of one of the preferred embodiments of the current invention;

FIG. 2 provides a schematic representation of one of the preferred uses of the current invention;

### DETAILED DESCRIPTION

Present invention benefits from realization that rapid development of energy harvesting technology allows ever-increasing levels of power to be harvested from people's motion. For instance, from resting to a fast sprint, the human body expends roughly 0.1 to 1.5 kilowatt. Only part of this energy is available for harvesting, but even a modest part of this vast energy pool can constitute a substantial power source. One particularly promising ways to extract energy from people's motion is by tapping their gait. Humans typically exert up to 130 percent of their weight across their shoes at heel strike and toe-off, and standard jogging sneakers cushioned soles can compress by up to a centimeter during a normal walk. For a 154-pound person, this indicates that about 7 Watt of power could be available per foot at a 1-Hertz stride from heel strike alone. A seminal discussion of the useful power available from human motion is given in the article by Thad Starner, “HUMAN-POWERED WEARABLE COMPUTING”, published in IBM Systems Journal, volume 35, Issue 3/4, year 1996, which is incorporated by reference herein in its entirety.

Numerous attempts were undertaken to incorporate human-powered energy harvesting devices in various wearable articles and especially in footwear that can be adapted for use with the current invention. Some of those methods are disclosed in U.S. Pat. Nos. 5,167,082, 5,495,682, 4,660,305, 6,182,378, 6,239,501, 6,255,799, 6,744,145, 6,281,594, which are incorporated by reference herein in their entirety.

In particular, in a pending U.S. patent application Ser. No. 11843045, entitled METHOD AND APPARATUS FOR ENERGY HARVESTING USING MICROFLUIDICS, inventor: Thomas Nikita Krupenkin, filed Aug. 22, 2007, a high-power microfluidics based energy harvester suitable for incorporation in footwear is disclosed. The disclosed energy harvester is capable of providing several watts of power, which makes it particularly suitable for use in the current invention.

Additionally, a detailed overview of the current art in the area of human-powered energy harvesting devices and suitable mechanical-to-electrical energy conversion methods, including electromagnetic, electrostatic, and piezoelectric, is given in the article by Joseph A. Paradiso and Thad Starner, “Energy Scavenging for Mobile and Wireless Electronics”, published in Pervasive Computing, p. 18, January-March 2005, which is incorporated by reference herein in its entirety.

The main idea of the present invention is to combine a human-motion-powered energy harvesting device with the wireless transceiver capable of receiving communications from personal mobile electronic devices in a low-power standard such as Bluetooth or Wibree and then retransmitting them (i.e. establishing a RF communication link) through a long-range high-power RF communication to a wide-area network, such as wide area cellular telephone network or WiMAX wide area network. Thus substantial decrease in power consumption by mobile devices can be achieved since most of the energy consumed by long-range RF transmission will be derived from the energy-harvesting device rather than from the mobile electronic devices themselves.

For the purpose of this application we define low-power, short-range communication signals as those that do not exceed radiated power of 120 milliwatt [mW]. Common examples of such RF signals include those conforming to Bluetooth Class 2 standard, with the power up to 2.5 mW and transmission range up to 10 meters [m]. Another example is Wibree standard, with the power up to 0.3 mW and transmission range up to 1 m. Yet another example of the low-power, short-range communication signals are those described by WiFi standard with the maximum power on the order of 100 mW and transmission range up to 100 m.

Similarly, for the purpose of this application we define long-range high-power RF communication signals as those that have radiated power in excess of 120 mW. Common examples of such RF signals include those conforming to CDMA2000, GSM or 3G standards, with the power up to 2000 mW and transmission range up to 22 miles. Another example is WiMAX standard, with the maximum power on the order of 2000 mW and transmission range up to 30 miles.

Those skilled in the art would be familiar with the details of the mentioned above RF communication standards, maximum radiated power allowed by those standards and other relevant requirements stipulated in those standards.

The following numerical example can further elucidate potential improvements in the power consumption of mobile electronic devices afforded by the present invention. Let us consider a mobile phone conforming to 3G standard and consuming about 1000 mW of power during regular voice communication. Replacing such long range RF communication with the short-range Bluetooth Class 2 communication, that consumes on the order of 2.5 mW power, would reduce the energy consumption of the phone by 1000 mW/2.5 mW=400 times. Thus the talk time afforded by a fully charged battery of such phone would also increase about 400 times. Given that many modern phones provide 2 to 5 hours of talk time under regular circumstances, the proposed invention would increase the available talk time of those phones to the range of 33 to 83 days.

Obviously, one has to interpret the above calculation as an order of magnitude estimate only, as mobile phones and other electronic devices consume power to perform other functions, aside from RF transmission and thus the actual gain in energy consumption might be less, but nevertheless, the above example clearly demonstrates that very substantial benefits in energy consumption can be afforded by the proposed invention.

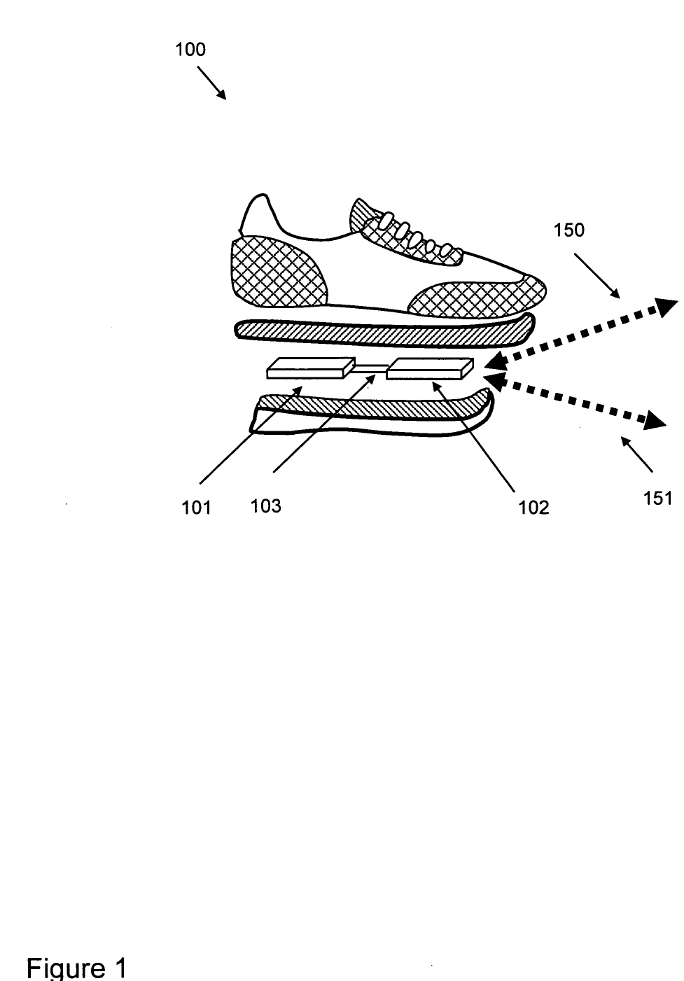

The details of the invention are best understood by considering specific preferred embodiments. One embodiment of the present invention is an apparatus. FIG. 1 presents schematic view of an exemplary embodiment 100 of an apparatus for reducing the energy consumed by mobile electronic devices during long-range radio frequency (RF) communications. The apparatus 100 comprises footwear-mounted transceiver 102, which is electrically coupled using coupling 103 to footwear-mounted energy harvesting device 101. Transceiver 102 is powered by energy harvesting device 101, which is adapted to derive energy from human gait. Transceiver 102 is capable of supporting both short-range low-power RF communication links 150 and long-range high-power RF links 151.

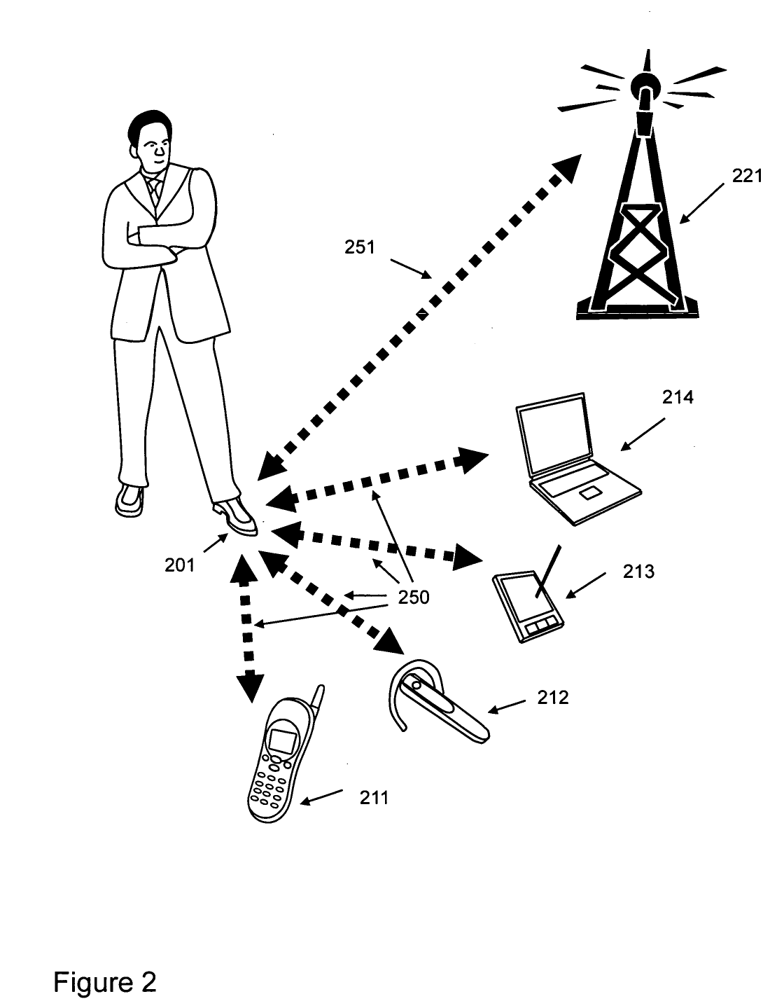

FIG. 2 presents a schematic representation of one of the possible uses of current invention. Mobile personal electronic devices such as cell phones 211, wireless Bluetooth headphones 212, personal digital assistants (PDA) 213, and laptops 214 communicate through low-energy short-range links 250 with a shoe-mounted transceiver 201, which, in turn, retransmits the signal to the cellular network base station 221 using high-power long range RF communication link 251.

Another embodiment of the current invention is a method of use. The method comprises providing RF communication means and energy-harvesting means. Said method further comprises generating electrical energy from human motion by said energy-harvesting means and utilizing this energy to power said RF communication means. Said method still further comprises receiving short-range low-power RF communication signals by said RF communication means from the mobile electronic devices and retransmitting the information received through said low-power signals through high-power long-range RF communication signals, thereby allowing said mobile electronic devices to establish a long-range RF communication with the remote recipient substantially utilizing the energy derived from the energy-harvesting means rather than the energy predominantly derived from said mobile electronic devices themselves.

Still another embodiment is a method that comprises manufacturing an apparatus for reducing the energy consumed by mobile electronic devices during long-range radio frequency (RF) communications. Said method comprises disposing RF communication means and energy-harvesting means in predetermined places as to allow said energy-harvesting means to produce useful electrical energy from human motion and as to allow said RF communication means unimpeded RF communication. Electrically coupling said RF communication means and said energy-harvesting means to allow said RF communication means utilize the electrical energy produced from human motion by said energy-harvesting means. Configuring said RF communications means to receive short-range low-power RF communication signals from said mobile electronic devices and retransmitting the information received through said low-power signals through high-power long-range RF communication signals, thereby allowing said mobile electronic devices to establish a long-range RF communication with the remote recipient substantially utilizing the energy derived from the energy-harvesting means rather than the energy predominantly derived from said mobile electronic devices themselves.

Although the present invention has been described in detail, those of ordinary skill in the art should understand that they could make various changes, substitutions and alterations herein without departing from the scope of the invention.

What is claimed is:

1. An apparatus for reducing the energy consumed by mobile electronic devices during long-range radio frequency (RF) communications comprising:
an energy-harvesting means and a radio frequency (RF) communication means;
said energy-harvesting means configured to capture mechanical energy from the human motion and convert it to useful electrical energy;
said energy-harvesting means and said RF communication means electrically coupled to allow said RF communication means utilize electrical energy generated by said energy-harvesting means;
said RF communication means configured to establish RF communications with the mobile electronic devices in its vicinity using low-power, short-range RF communication signals;
said RF communication means further configured to retransmit the information received through said short range RF communication signals using high-power long-range communication signals,
thereby allowing said mobile electronic devices to establish a long-range RF communication with the remote recipients substantially utilizing the energy derived from the energy-harvesting means rather than the energy predominantly derived from said mobile electronic devices themselves.

2. The apparatus of claim 1, wherein said energy harvesting means is disposed in footwear.

3. The apparatus of claim 1, wherein said RF communication means is disposed in footwear.

4. The apparatus of claim 1, wherein said energy harvesting means and said RF communication means are disposed in footwear.

5. The apparatus of claim 1, wherein said energy harvesting means is configured to utilize electromagnetic or electrostatic force based mechanical-to-electrical energy conversion to produce useful electrical energy from human motion.

6. The apparatus of claim 1, wherein said energy harvesting means is configured to utilize piezoelectric based mechanical-to-electrical energy conversion to produce useful electrical energy from human motion.

7. The apparatus of claim 1, wherein said energy harvesting means is configured to utilize microfluidics based mechanical-to-electrical energy conversion to produce useful electrical energy from human motion.

8. The apparatus of claim 1, wherein said energy harvesting means is configured to utilize any combination of electromagnetic, electrostatic, piezoelectric, or microfluidics based mechanical-to-electrical energy conversion to produce useful electrical energy from human motion.

9. The apparatus of claim 1, wherein said low-power, short-range RF communication signals conform to Bluetooth RF communication standard.

10. The apparatus of claim 1, wherein said low-power, short-range RF communication signals conform to Wibree RF communication standard.

11. The apparatus of claim 1, wherein said low-power, short-range RF communication signals conform to WiFi RF communication standard.

12. The apparatus of claim 1, wherein said high-power long-range communication signals conform to CDMA wide area cellular telephone network communication standard.

13. The apparatus of claim 1, wherein said high-power long-range communication signals conform to GSM wide area cellular telephone network communication standard.

14. The apparatus of claim 1, wherein said high-power long-range communication signals conform to any of the International Telecommunication Union (ITU) wide area cellular telephone network family of standards developed under the International Mobile Telecommunications program (IMT-2000) including, but not limited to 2G, 2.5G, 3G, 3.5G, and 4G standards.

15. The apparatus of claim 1, wherein said high-power long-range communication signals conform to WiMAX wide area network RF communication standard.

16. Method of reducing the energy consumed by mobile electronic devices during long-range radio frequency (RF) communications comprising steps of:
providing RF communication means and energy-harvesting means;
generating useful electrical energy from human motion by said energy-harvesting means;
utilizing said useful electrical energy to power said RF communication means;
establishing communication between said RF communication means and mobile electronic devices in its vicinity using short-range low-power RF communication signals;
retransmitting the information received through said low-power signals through high-power long-range RF communication signals,
thereby allowing said mobile electronic devices to establish a long-range RF communication with the remote recipients substantially utilizing the energy derived from the energy-harvesting means rather than the energy predominantly derived from said mobile electronic devices themselves.

17. The method of claim 16, further comprising a step of disposing said energy harvesting means in footwear.

18. The method of claim 16, further comprising a step of disposing said RF communication means in footwear.

19. The method of claim 16, further comprising a step of disposing said energy harvesting means and said RF communication means in footwear.

20. The method of claim 16, wherein said step of generating useful electrical energy from human motion utilizes electromagnetic or electrostatic force based mechanical-to-electrical energy conversion to produce useful electrical energy from human motion.

21. The method of claim 16, wherein said step of generating useful electrical energy from human motion utilizes piezoelectric based mechanical-to-electrical energy conversion to produce useful electrical energy from human motion.

22. The method of claim 16, wherein said step of generating useful electrical energy from human motion utilizes microfluidics based mechanical-to-electrical energy conversion to produce useful electrical energy from human motion.

23. The method of claim 16, wherein said step of generating useful electrical energy from human motion utilizes any combination of electromagnetic, electrostatic, piezoelectric, or microfluidics based mechanical-to-electrical energy conversion to produce useful electrical energy from human motion.

24. The method of claim 16, wherein said low-power, short-range RF communication signals conform to Bluetooth RF communication standard.

25. The method of claim 16, wherein said low-power, short-range RF communication signals conform to Wibree RF communication standard.

26. The method of claim 16, wherein said low-power, short-range RF communication signals conform to WiFi RF communication standard.

27. The method of claim 16, wherein said high-power long-range communication signals conform to CDMA wide area cellular telephone network communication standard.

28. The method of claim 16, wherein said high-power long-range communication signals conform to GSM wide area cellular telephone network communication standard.

29. The method of claim 16, wherein said high-power long-range communication signals conform to any of the International Telecommunication Union (ITU) wide area cellular telephone network family of standards developed under the International Mobile Telecommunications program (IMT-2000) including, but not limited to 2G, 2.5G, 3G, 3.5G, and 4G standards.

30. The method of claim 16, wherein said high-power long-range communication signals conform to WiMAX wide area network RF communication standard.

31. A method, comprising:
manufacturing an apparatus for reducing the energy consumed by mobile electronic devices during long-range radio frequency (RF) communications, comprising:
disposing RF communication means and energy-harvesting means in predetermined places as to allow said energy-harvesting means to produce useful electrical energy from human motion and as to allow said RF communication means unimpeded RF communication;
electrically coupling said RF communication means and said energy-harvesting means to allow said RF communication means utilize the electrical energy produced from human motion by said energy-harvesting means;
configuring said RF communications means to receive and transmit short-range low-power RF communication signals in order to establish communication with mobile electronic devices in its vicinity;
configuring said RF communications means to retransmit the information received through said low-power signals through high-power long-range RF communication signals.

32. The method of claim 31, wherein said predetermined places include footwear.

33. The method of claim 31, wherein said energy harvesting means is further configured to utilize electromagnetic or electrostatic force based mechanical-to-electrical energy conversion to produce useful electrical energy from human motion.

34. The method of claim 31, wherein said energy harvesting means is further configured to utilize piezoelectric based mechanical-to-electrical energy conversion to produce useful electrical energy from human motion.

35. The method of claim 31, wherein said energy harvesting means is further configured to utilize microfluidics based mechanical-to-electrical energy conversion to produce useful electrical energy from human motion.

36. The method of claim 31, wherein said energy harvesting means is further configured to utilize any combination of electromagnetic, electrostatic, piezoelectric, or microfluidics based mechanical-to-electrical energy conversion to produce useful electrical energy from human motion.

37. The method of claim 31, wherein said low-power, short-range RF communication signals conform to Bluetooth RF communication standard.

38. The method of claim 31, wherein said low-power, short-range RF communication signals conform to Wibree RF communication standard.

39. The method of claim 31, wherein said low-power, short-range RF communication signals conform to WiFi RF communication standard.

40. The method of claim 31, wherein said high-power long-range communication signals conform to CDMA wide area cellular telephone network communication standard.

41. The method of claim 31, wherein said high-power long-range communication signals conform to GSM wide area cellular telephone network communication standard.

42. The method of claim 31, wherein said high-power long-range communication signals conform to any of the International Telecommunication Union (ITU) wide area cellular telephone network family of standards developed under the International Mobile Telecommunications program (IMT-2000) including, but not limited to 2G, 2.5G, 3G, 3.5G, and 4G standards.

43. The method of claim 31, wherein said high-power long-range communication signals conform to WiMAX wide area network RF communication standard.
